(19) United States
(12) Patent Application Publication
(10) Pub. No.: US 2014/0047753 A1
(43) Pub. Date: Feb. 20, 2014

(54) Grip for a Slide of a Semiautomatic Firearm

(71) Applicants: David A. Grossman, Mascoutah, IL (US); Jonathon D. Grossman, Mascoutah, IL (US)

(72) Inventors: David A. Grossman, Mascoutah, IL (US); Jonathon D. Grossman, Mascoutah, IL (US)

(21) Appl. No.: 13/588,722

(22) Filed: Aug. 17, 2012

(51) Int. Cl. F41C 23/00; B32B 37/00; B23P 11/00

(52) U.S. Cl. 42/72; 29/428; 156/60

(57) ABSTRACT

A semiautomatic single action hand gun comprises a slide with a contoured grip on a breach end of the slide. A method is also disclosed. In accordance with one step of the method a single action semiautomatic firearm is provides. In accordance with another step of the method, a contoured grip for a slide of the firearm is provided. The grip comprises a plurality of depressions in an elongated strip with the depressions generally sized to accommodate the fingers of a user and the strip generally sized to fit on a lateral side of a slide of firearm. In accordance with another step in the method, the grip is applied to a lateral side of a slide of the firearm.

### BACKGROUND OF THE INVENTION

Generally speaking, a semiautomatic firearm is powered by the discharge of the previous round to load a fresh round into the chamber, so that a round may be fired each time the trigger is pulled. The semiautomatic firearm harnesses the energy from the discharge of one round typically via recoil operation, blowback, or gas operation. After a round is fired, the spent casing is ejected and a new round for the magazine is loaded in the chamber, allowing another shot to be fired as soon as the trigger is pulled again. In a single-action, semiautomatic firearm, the pistol must be readied for operation or “cocked” by first operating a slide or bolt, or, if a round is already chambered, by cocking the hammer manually. The semiautomatic firearm may automatically be cocked when the slide is first racked to chamber a round.

Racking the slide can be difficult when the weapon is wet or dirty. Many semiautomatic single-action hand guns have serrations on the breach end of the slide for this purpose. But, these often prove insufficient to allow the user to grip the slide for racking the slide. This disclosure relates to a development that avoids this problem. Further features and advantages, as well as the structure and operation of various embodiments, are described in detail below with reference to the accompanying drawings.

### BRIEF DESCRIPTION OF THE DRAWINGS

FIG. 1 shows a partial perspective view of a contoured grip for a right side of a slide of a semiautomatic handgun;

FIG. 2 is alternative partial perspective view of the grip of FIG. 1;

FIG. 3 shows a partial perspective view of a contoured grip for a left side of a slide of a semiautomatic handgun;

FIG. 4 is partial alternative perspective view of the grip of FIG. 3;

FIG. 5 is a partial side elevational view of the grip of FIG. 1;

FIG. 6 is a partial side elevational view of the grip of FIG. 2;

FIG. 7 is a partial front view of the grip of FIG. 1;

FIG. 8 is a partial rear view of the grip of FIG. 1;

FIG. 9 is a top view of the grip of FIG. 1;

FIG. 10 is a partial front view of the grip of FIG. 2;

FIG. 11 is a partial rear view of the grip of FIG. 2;

FIG. 12 is a top view of the grip of FIG. 2;

FIG. 13 is a partial front view of a handgun with the grips of FIGS. 1 and 2 applied to left and right sides of a slide of the handgun;

FIG. 14 is a partial rear view of a handgun with the grips of FIGS. 1 and 2 applied to left and right sides of a slide of the handgun; and

FIG. 15 is a top view of a handgun with the grips of FIGS. 1 and 2 applied to left and right sides of a slide of the handgun.

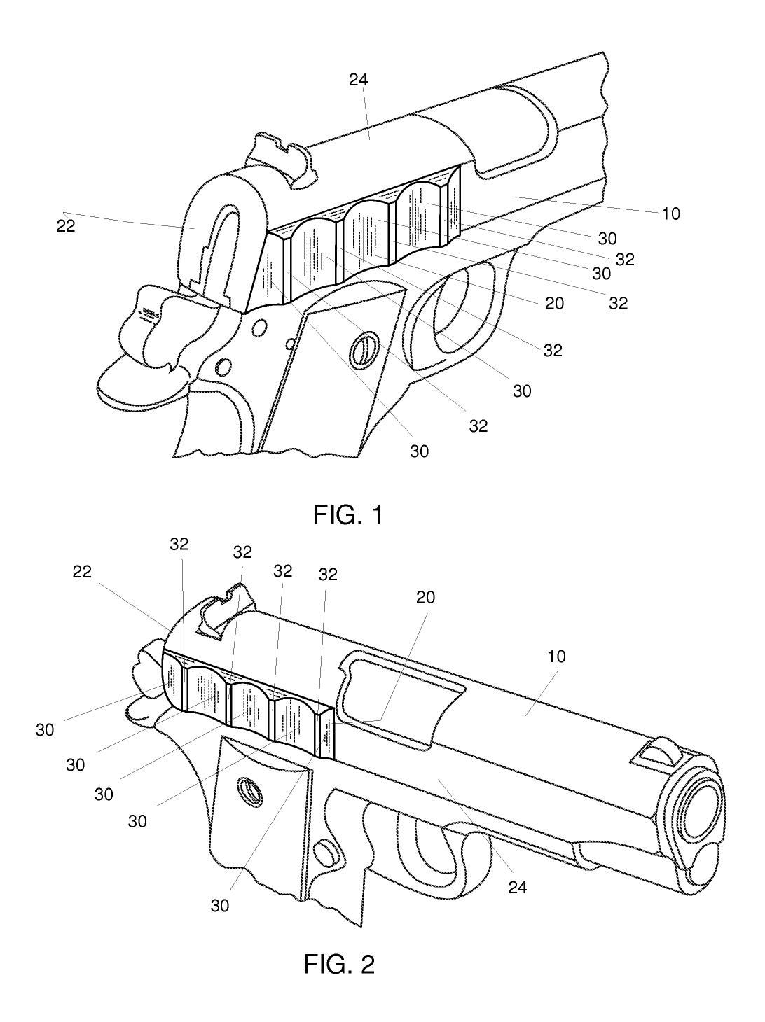

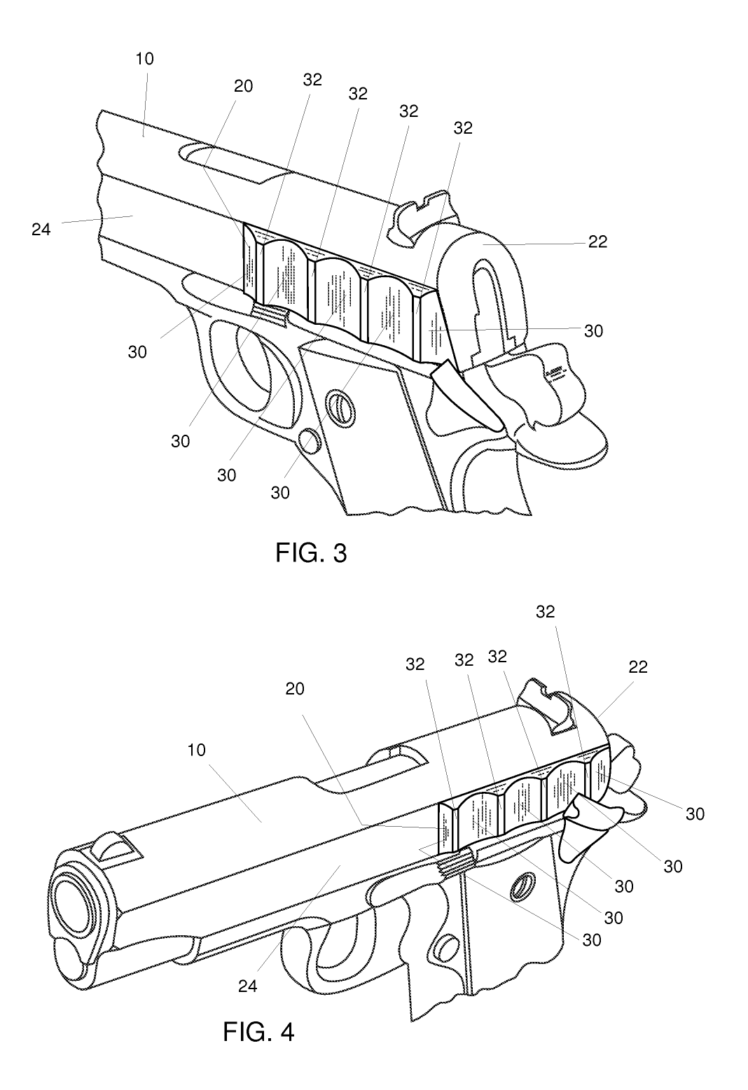

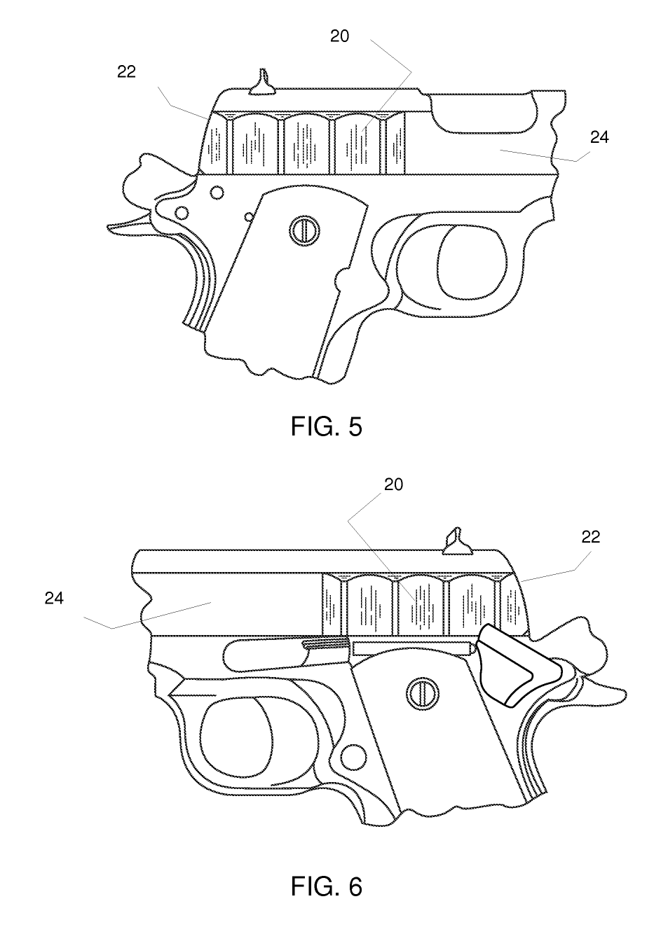

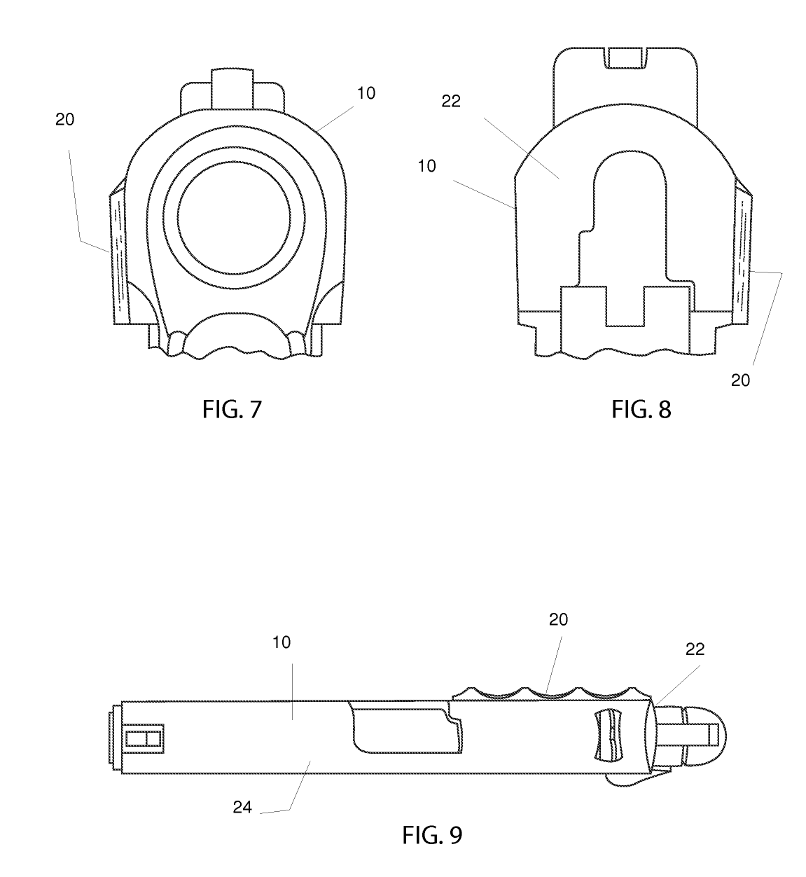

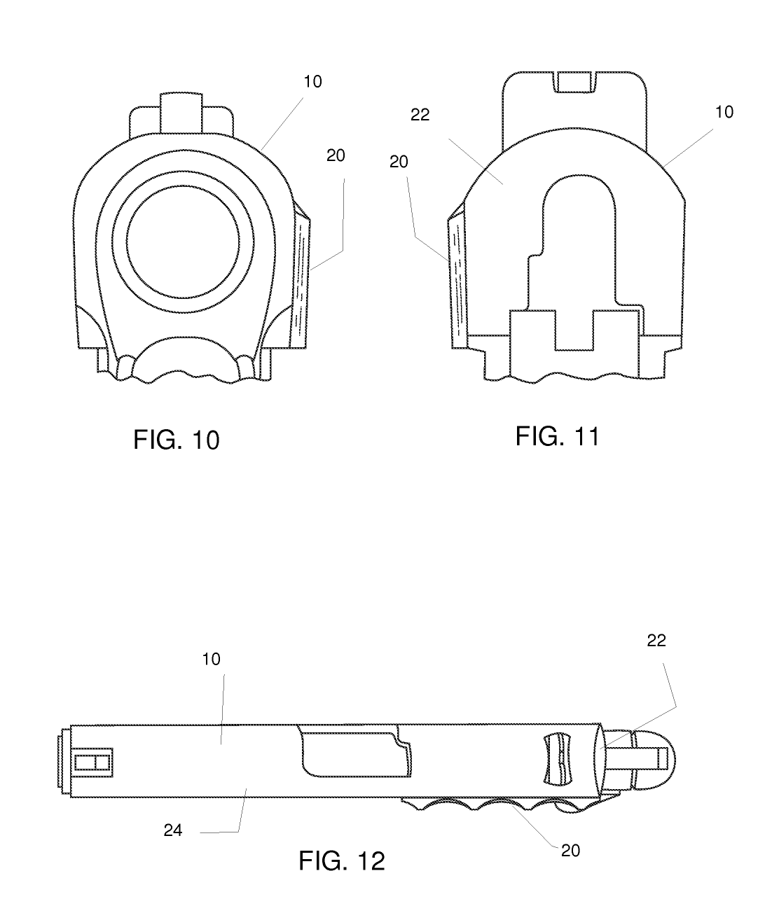

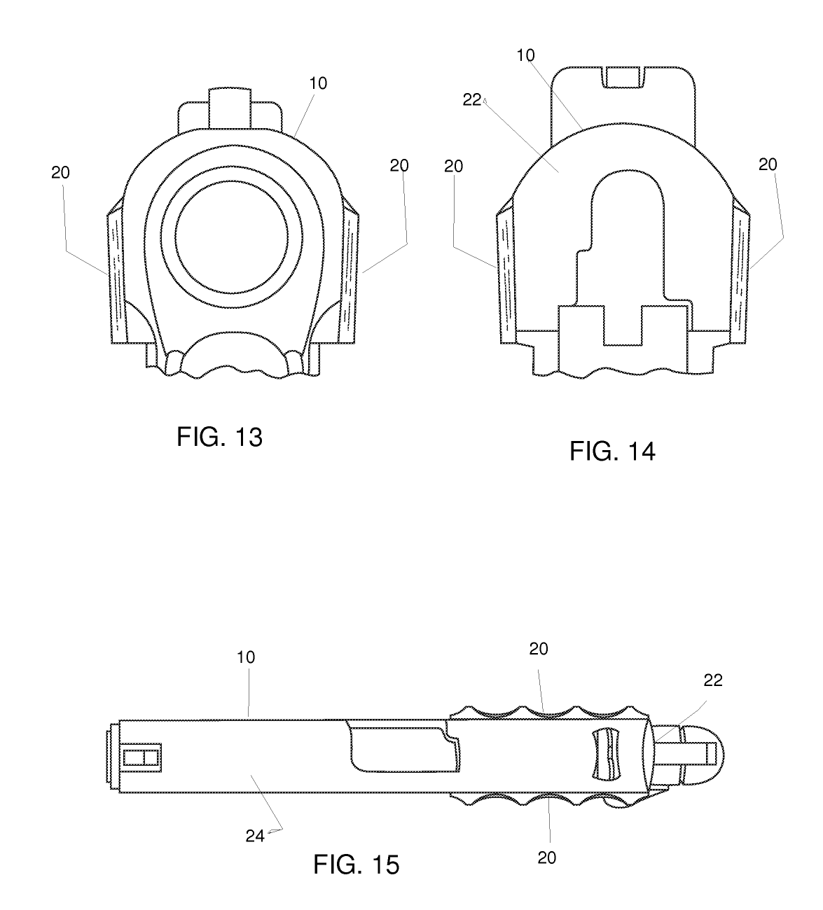

### DETAILED DESCRIPTION

The drawing figures show a semiautomatic handgun 10 contoured grip 20 which may be applied to the breach end 22 of a slide 24 of the handgun. The contoured grip 20 may be applied one side of the slide or both sides of the slide as may be desired. The drawings are not intended to be limited to a grip applied to one side and/or both sides. Although the drawings show a Model 1911 type hand gun, the principles described herein may be applied to any firearm that relies on the principle of racking the slide to chamber a round.

Preferably, the grip 20 has depressions 30 separated by lands 32 that enable a user to apply his or her fingers in the depressions for racking the slide. The lands are disposed between the user's fingers. A grip may have three full depressions and four lands. Outboard of the outer land, a partial depression may be formed to accommodate a pinky finger and/or index finger depending upon how a user uses the grip (left side or right side).

The grip 20 may be provided as a kit and applied to an existing slide in a retro-fitting type of operation. In that regard, the grip may be formed from a rubberized material of material adhered to the lateral sides of the firearm. The grip may be applied over existing serrations formed in the slide of the firearm. The grip may be formed by machining contours into metallic or other fairly rigid materials which may be mechanically attached to the lateral sides of the slide. In the alternative, the grip as described herein may be formed monolithically with the slide during manufacture of the firearm. Preferably, the grip is sized to be applied to one or both of the lateral sides of the firearm in a manner that does not interfere with the safety, or sights associated with the breech end of the firearm.

The embodiments were chosen and described in order to best explain the practical application to thereby enable others skilled in the art to best utilize the principles disclosed herein in various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A semiautomatic single action hand gun comprising a slide with a contoured grip on a breech end of the slide.

2. The firearm of claim 1, wherein the contoured grip comprises depressions generally sized to accommodate the fingers of a user.

3. The firearm of claim 2, wherein lands define the depressions of the contoured grip.

4. The firearm of claim 3, further comprising a partial depression outboard a land.

5. The firearm of claim 4, further comprising a second partial depression outboard a second land.

6. The firearm of claim 2, wherein the contoured grip has at least three depressions.

7. The firearm of claim 6, wherein the contoured grip has at least four depressions.

8. The hand gun of claim 1, wherein the grip is applied to both sides of the slide of the firearm.

9. The firearm of claim 1, wherein the grip is monolithically formed with a slide.

10. The firearm of claim 1, wherein the grip is adhered to a lateral side of the slide.

11. A method comprising:
providing a single action semiautomatic firearm;
providing a contoured grip for a slide of the firearm, the grip comprising a plurality of depressions in an elongated strip with each of the depressions generally sized to accommodate the fingers of a user and the strip generally sized to fit solely on a lateral side of a slide of firearm; and
applying the grip to a lateral side of a slide of the firearm.

12. The method of claim 11, further comprising:
adhering the grip to the lateral side of the slide of the firearm.

13. The method of claim 11, further comprising:
mechanically attaching the grip to the lateral side of the slide of the firearm.

14. The method of claim 11, further comprising:
applying a second contoured grip to an opposite lateral side of the slide of the firearm.

15. The method of claim 14, wherein the second contoured grip is mechanically attached to the opposite side of the slide of the firearm.

16. The method of claim 14, wherein the second contoured grip is adhered to the opposite lateral side of the firearm.

17. The method of claim 11, wherein lands define the depressions of the contoured grip.

18. The method of claim 17, further comprising a partial depression outboard a land.

19. The method of claim 11, wherein the contoured grip has at least three depressions.

20. The method of claim 19, wherein the contoured grip has at least four depressions.
